(19) United States
(12) Patent Application Publication
(10) Pub. No.: US 2010/0287563 A1
(43) Pub. Date: Nov. 11, 2010

(54) DEVICE CONTROL APPARATUS AND DEVICE CONTROL PROGRAM

(75) Inventor: Yuri Kishita, Yokkaichi-shi (JP)

Correspondence Address: OLIFF & BERRIDGE, PLC, P.O. BOX 320850, ALEXANDRIA, VA, 22320-4850, US

(73) Assignees: AutoNetworks Technologies, Ltd., Yokkaichi-shi (JP); Sumitomo Wiring Systems, Ltd., Yokkaichi-shi (JP); Sumitomo Electric Industries, Ltd., Osaka-shi (JP)

(21) Appl. No.: 12/863,485

(22) PCT Filed: Jan. 26, 2009
(86) PCT No.: PCT/JP2009/051191

§ 371 Date: Jul. 19, 2010

(30) Foreign Application Priority Data
Jan. 24, 2008 (JP) 2008-014033

(51) Int. Cl. G06F 9/46

(52) U.S. Cl. 719/313

(57) ABSTRACT

A program of an application layer (upper layer) receives input information supplied from a platform layer (lower layer) and abstracts the information by an input information abstraction part. Based on the abstracted information, determination parts, a prioritized condition determination section and an information processing section make determinations and perform information processing, for example. A processing result obtained by the information processing section is converted into an information format suitable for the platform layer by an output information conversion section, and is outputted therefrom. When a format of information exchanged between the application layer and platform layer, for example, is changed, changes may be made to the input information abstraction part and the output information conversion section of the program of the application layer.

This application is the national phase under 35 U.S.C. §371 of PCT International Application No. PCT/JP2009/051191 which has an International filing date of Jan. 26, 2009 and designated the United States of America.

### BACKGROUND

1. Technical Field

The present invention relates to a device control apparatus and a device control program which are capable of controlling various devices such as those installed in a vehicle, and capable of facilitating development and change thereof, for example.

2. Description of Related Art

In recent years, a large number of functions of vehicles have been electronified, and a large number of electronic devices (hereinafter referred to as “in-vehicle devices”) have been installed in vehicles. Further, since functions of vehicles tend to be technologically advanced, in-vehicle devices are technologically advanced, and the number of in-vehicle devices to be installed tends to increase. Therefore, control programs and control apparatuses, for example, for controlling a large number of in-vehicle devices might be increased in size and in complexity, thus causing problems that it becomes difficult to develop the control programs and control apparatuses, for example, and increases in development period and development cost thereof, for example, are induced.

In Japanese Patent Application Laid-Open No. 2000-97102, there has been proposed a vehicle control apparatus capable of reducing the number of man-hours for software development incident to a change in hardware by applying an object-oriented designed program to an engine control program. In this vehicle control apparatus, a control program is hierarchically organized into an application layer (AP layer) and a platform layer (PF layer). The AP layer is described by an object-oriented designed program that does not depend on hardware. On the other hand, the PF layer is described by an object-oriented designed program that depends on hardware, and is further hierarchically divided into three layers including an upper-level layer, an intermediate-level layer and a lower-level layer, which are formed by a sensor actuator layer, a device driver layer, and a virtual MPU (Micro Processing Unit) layer, respectively.

In the vehicle control apparatus according to Japanese Patent Application Laid-Open No. 2000-97102, the PF layer is provided between the AP layer and hardware, thereby allowing physical information from hardware to be converted into logical information in the PF layer, and allowing the information to be abstracted therein; thus, even when a change is made to hardware, it is only necessary to make a change to the PF layer, and it is unnecessary to make a change to the AP layer. Hence, program development can be facilitated, and the foregoing problems such as increases in development period and development cost, for example, can be eliminated.

### SUMMARY

However, in the vehicle control apparatus according to Japanese Patent Application Laid-Open No. 2000-97102, there arises the necessity to make a change to the AP layer when information inputted to the AP layer from the PF layer is changed due to a change in the PF layer, i.e., when an input/output condition between the PF layer and AP layer is changed, for example. The PF layer can perform abstraction of information concerning hardware; therefore, when a change made to hardware is a minor one, the change may be dealt with by just making a change to the PF layer. However, when a change made to a hardware configuration of a vehicle is a major one (e.g., when new hardware is added along with a design change in a vehicle, or when a program is diverted for a different vehicle type), the input/output condition between the PF layer and AP layer might be changed, which makes it necessary to make a change to the AP layer, thereby inducing increases in program development period and development cost, for example.

The present invention has been made in view of the above-described circumstances, and its object is to provide a device control apparatus and a device control program which allow a program (processing section) for controlling a device to be hierarchically organized to not only enable abstraction of an input/output between hardware and a lower-layer program (PF layer), but also enable abstraction of an input/output between the lower-layer program and upper-layer program (AP layer), thereby making it possible to reduce an amount of changes in the upper-layer program incident to a change in the lower-layer program, and to suppress increases in development period and development cost, for example.

A device control apparatus according to the present invention is a device control apparatus for controlling an operation of a device, wherein the device control apparatus includes: a first processing section for exchanging information with the device; and a second processing section for exchanging information with the first processing section, and wherein the second processing section includes: an abstraction part for generating abstracted information on the basis of a single piece or a plurality of pieces of information received from the first processing section, the abstracted information being generated by abstracting the received information; and a control information processing section for performing information processing concerning control of the device by using the generated abstracted information.

Another aspect according to the present invention provides the device control apparatus, wherein the second processing section further includes a conversion section for converting abstracted information, generated by the information processing performed by the control information processing section, into an information format suitable for the first processing section, and wherein the information, converted by the conversion section, is supplied to the first processing section.

Still another aspect according to the present invention provides the device control apparatus, wherein the device control apparatus includes a shared processing section for storing information received from one or a plurality of the first processing sections and used by a plurality of the second processing sections, and for performing information processing on the information.

Yet another aspect according to the present invention provides the device control apparatus, wherein the second processing section includes: a basic processing part for performing information processing concerning information of a function common to different devices; and a unique processing part for performing information processing concerning information of a function unique to the associated device.

Still yet another aspect according to the present invention provides the device control apparatus, wherein information exchangeable between the second processing section and the first processing section is limited.

Further, a device control apparatus according to the present invention is a device control apparatus for controlling an operation of a device, wherein the device control apparatus includes: an abstraction part for generating abstracted information on the basis of a single piece or a plurality of pieces of information received from an other device that exchanges information with the device, the abstracted information being generated by abstracting the received information; and a control information processing section for performing information processing concerning control of the device by using the generated abstracted information.

Another aspect according to the present invention provides the device control apparatus, wherein the device control apparatus further includes a conversion section for converting abstracted information, generated by the information processing performed by the control information processing section, into an information format suitable for the other device, and wherein the information, converted by the conversion section, is supplied to the other device.

Furthermore, a device control program according to the present invention is a device control program for causing a computer to control an operation of a device, wherein the device control program includes: a first program for exchanging information with the device; and a second program for exchanging information with the first program, and wherein the second program includes the steps of: causing the computer to generate abstracted information on the basis of a single piece or a plurality of pieces of information received from the first program, the abstracted information being generated by abstracting the received information; and causing the computer to perform information processing concerning control of the device by using the generated abstracted information.

Another aspect according to the present invention provides the device control program, wherein the second program further includes the steps of: causing the computer to convert abstracted information, generated by the information processing, into an information format suitable for the first program; and causing the computer to supply the converted information to the first program.

Still another aspect according to the present invention provides the device control program, wherein the device control program includes: a first program group including one or a plurality of the first programs; and a second program group including a plurality of the second programs, and wherein the second program group includes a shared program for storing information received from the first program of the first program group and used by a plurality of the second programs, and for performing information processing on the information.

Yet another aspect according to the present invention provides the device control program, wherein the second program includes: a basic program portion for performing information processing concerning information of a function common to different devices; and a unique processing portion for performing information processing concerning information of a function unique to the associated device.

Still yet another aspect according to the present invention provides the device control program, wherein information exchangeable between the second program and the first program is limited.

Moreover, a device control program according to the present invention is a device control program for causing a computer to control an operation of a device, wherein the device control program includes the steps of: causing the computer to generate abstracted information on the basis of a single piece or a plurality of pieces of information received from an other program that exchanges information with the device, the abstracted information being generated by abstracting the received information; and causing the computer to perform information processing concerning control of the device by using the generated abstracted information.

Another aspect according to the present invention provides the device control program, wherein the device control program further includes the steps of: causing the computer to convert abstracted information, generated by the information processing, into an information format suitable for the other program; and causing the computer to supply the converted information to the other program.

Further, a device control program according to the present invention is a device control program for causing a device control apparatus to control an operation of a device, the device control apparatus including: a communication section for receiving and transmitting information from and to one or a plurality of devices; an information processing section for performing information processing concerning control of the device on the basis of the information received by the communication section; and a storage section for storing information concerning the information processing, wherein the device control program includes: a first program for causing the device control apparatus to exchange information with the device by the communication section; and a second program for causing the device control apparatus to exchange information with the first program via the storage section, and wherein the second program includes the steps of: causing the device control apparatus to generate abstracted information on the basis of a single piece or a plurality of pieces of information received from the first program via the storage section, the abstracted information being generated by abstracting the received information by the information processing section; and causing the device control apparatus to perform, using the generated abstracted information, information processing concerning the control of the device by the information processing section.

Another aspect according to the present invention provides the device control program, wherein the second program further includes the steps of: causing the device control apparatus to convert abstracted information, generated by the information processing, into an information format suitable for the first program by the information processing section; and causing the device control apparatus to store the converted information in the storage section by the information processing section, thus supplying the information to the first program via the storage section.

In the present invention, the first processing section exchanges information with the device, the first processing section supplies, to the second processing section, the information supplied from the device, and the first processing section performs control of the device based on the information supplied from the second processing section. Thus, there can be provided a three-level hierarchy including the device, the first processing section and the second processing section, and a slight change in the device can be dealt with by just making a change to the first processing section. Moreover, in the second processing section, on the basis of a single piece or a plurality of pieces of information received from the first processing section, the abstraction part generates abstracted information by abstracting the received information, and the control information processing section performs information processing concerning the control of the device on the basis of this abstracted information. Thus, even when a change is made, for example, in a format of information supplied from the first processing section to the second processing section, the change can be dealt with by just making a change to the abstraction part of the second processing section.

Further, in the present invention, the control information processing section in the second processing section performs information processing on the basis of the abstracted information, and generates abstracted information as a result of the information processing; then, when the information processing result is supplied from the second processing section to the first processing section, the conversion section converts the abstracted information, resulting from the information processing, into an information format suitable for the first processing section (i.e., a process inverse to abstraction is performed), and the converted information is supplied to the first processing section. Thus, even when a change is made, for example, in a format of information supplied from the second processing section to the first processing section, the change can be dealt with by just making a change to the part of the second processing section, which converts the abstracted information into an information format suitable for the first processing section.

Furthermore, in the present invention, the device control apparatus includes one or a plurality of the first processing sections and a plurality of the second processing sections. Although information is supplied to each of a plurality of the second processing sections from one or a plurality of the first processing sections, a single piece of information from the first processing section(s) may be used by a plurality of the second processing sections. Therefore, the device control apparatus is configured so that the shared processing section shared by a plurality of the second processing sections is provided, and the shared processing section stores shared information and performs information processing thereon, for example. Thus, it is unnecessary for a plurality of the second processing sections to store the same information, and in addition, it is unnecessary for a plurality of the second processing sections to perform the same information processing on the same information, thereby making it possible to realize a reduction in storage capacity, an enhancement in processing speed, etc. for the second processing section.

Besides, in the present invention, when a plurality of devices such as a large number of devices installed in a vehicle are controlled, a plurality of the second processing sections are provided so as to be associated with the respective devices, and the respective second processing sections perform information processing concerning the respective devices. For example, in order to control in-vehicle devices such as a wiper, a light and a door lock of the vehicle, the second processing section for wiper control, the second processing section for light control, and the second processing section for door lock control are provided. In addition, for example, when a plurality of wipers such as a front wiper and a rear wiper are installed in the vehicle, the second processing section for the front wiper and the second processing section for the rear wiper, for example, may be provided.

For example, wipers are installed in vehicles even when vehicle types are different, but functions or the like of the wipers might be different. Therefore, the second processing section includes a combination of the basic processing part and the unique processing part so that the basic processing part performs information processing concerning a part having a function common to different devices such as wipers of different vehicle types, and the unique processing part performs information processing concerning a part having a different function. Further, for example, even when wipers are installed, a front wiper and a rear wiper each have a common function and a different function. Therefore, the device control apparatus may be configured so that the basic processing part performs information processing concerning a function common to both of the wipers, and the unique processing part performs information processing concerning a function different between the front wiper and rear wiper. Thus, when the device control apparatus is used for a plurality of vehicle types having devices with different functions, it is only necessary to make a change only to the unique processing section. Furthermore, the second processing section of the rear wiper can be easily created by diverting the basic processing part of the front wiper. Hence, reductions in development period and development cost of the second processing sections, and effective reutilization of resources can be realized.

Moreover, in the present invention, information supplied from the first processing section to the second processing section, and information supplied from the second processing section to the first processing section are limited. Thus, invalid information access to the first processing section from the second processing section can be prevented, thereby making it possible to increase reliability of the device control apparatus and that of a device operation.

In the present invention, the first program exchanges information with the device, the first program performs abstraction by changing the information supplied from the device into a predetermined information format, the first program supplies the abstracted information to the second program, and the first program controls the device based on information supplied from the second program. Thus, there can be provided a three-level hierarchy including the device, the first program and the second program, and a slight change in the device can be dealt with by just making a change to the first program. Moreover, on the basis of a single piece or a plurality of pieces of information received from the first program, the second program generates abstracted information by abstracting the received information, and performs information processing concerning control of the device on the basis of this abstracted information. Thus, even when a change is made, for example, in a format of information supplied from the first program to the second program, the change can be dealt with by just making a change to the part of the second program, which generates abstracted information.

Further, in the present invention, the second program performs information processing on the basis of the abstracted information, and generates abstracted information as a result of the information processing; then, when the information processing result is supplied from the second program to the first program, the abstracted information, resulting from the information processing, is converted into an information format suitable for the first program (i.e., a process inverse to abstraction is performed), and the converted information is supplied to the first program. Thus, even when a change is made, for example, in a format of information supplied from the second program to the first program, the change can be dealt with by just making a change to the part of the second program, which converts the abstracted information into an information format suitable for the first program.

Furthermore, in the present invention, the first program group includes one or a plurality of the first programs, and the second program group includes a plurality of the second programs. Although each first program of the first program group supplies information to the respective second programs of the second program group, a single piece of information from the first program(s) may be used by a plurality of the second programs. Therefore, the device control program is structured so that the shared program shared by a plurality of the second programs is provided in the second program group, and the shared program stores shared information and performs information processing thereon, for example. Thus, it is unnecessary for a plurality of the second programs to store the same information, and in addition, it is unnecessary for a plurality of the second programs to perform the same information processing on the same information, thereby making it possible to realize a reduction in storage capacity, an enhancement in processing speed, etc. for the second program group.

Besides, in the present invention, when a plurality of devices such as a large number of devices installed in a vehicle are controlled, a plurality of the second programs are provided so as to be associated with the respective devices, and the respective second programs perform information processing concerning the respective devices. For example, in order to control in-vehicle devices such as a wiper, a light and a door lock of the vehicle, the second program for wiper control, the second program for light control, and the second program for door lock control are provided. In addition, for example, when a plurality of wipers such as a front wiper and a rear wiper are installed in the vehicle, the second program for the front wiper and the second program for the rear wiper, for example, may be provided.

For example, wipers are installed in vehicles even when vehicle types are different, but functions or the like of the wipers might be different. Therefore, the second program includes a combination of the basic program portion and unique program portion so that the basic program portion performs information processing concerning a part having a function common to different devices such as wipers of different vehicle types, and the unique program portion performs information processing concerning a part having a different function. Further, for example, even when wipers are installed, a front wiper and a rear wiper each have a common function and a different function. Therefore, the device control program may be structured so that the basic program portion performs information processing concerning a function common to both of the wipers, and the unique program portion performs information processing concerning a function different between the front wiper and rear wiper. Thus, when the device control program is used for a plurality of vehicle types having devices with different functions, it is only necessary to make a change only to the unique processing portion. Furthermore, the second program of the rear wiper can be easily created by diverting the basic program portion of the front wiper. Hence, reductions in development period and development cost of the second programs, and effective reutilization of program resources can be realized.

Moreover, in the present invention, information supplied from the first program to the second program, and information supplied from the second program to the first program are limited. Thus, invalid information access to the first program from the second program can be prevented, thereby making it possible to increase reliability of the device control program and that of a device operation.

In the present invention, the device control apparatus is configured so that the device control apparatus is hierarchically organized into the first processing section for exchanging information with the device and the second processing section for exchanging information with the first processing section, and the second processing section generates abstracted information by abstracting the information, received from the first processing section, by the abstraction part, and performs information processing on the basis of the abstracted information by the control information processing section; thus, even when a change is made, for example, in a format of information exchanged between the first processing section and the second processing section, it is only necessary to make a change only to the abstraction part of the second processing section, thereby making is possible to suppress increases in development period and development cost, for example, of the device control apparatus. Further, the second processing section exclusive of the abstraction part, i.e., the control information processing section for performing main information processing, can be developed independently of the first processing section, and therefore, facilitation and speed-up of development of the second processing section can be realized.

Furthermore, in the present invention, the device control apparatus is configured to include the shared processing section for, for example, storing information supplied from one or a plurality of the first processing sections and shared by a plurality of the second processing sections, and for performing information processing on this information; thus, it is unnecessary for a plurality of the second processing sections to store the same information, and it is unnecessary for a plurality of the second processing sections to perform the same information processing, thereby making it possible to save memory resources of the device control apparatus and to enhance the processing speed thereof.

Moreover, in the present invention, the second processing section associated with the device includes the basic processing part concerning a function common to different devices, and the unique processing part concerning a different function; thus, resources of the second processing section can be effectively reutilized, and therefore, reductions in development period and development cost of the device control apparatus can be achieved with more reliability.

In the present invention, the device control program is structured so that the device control program is hierarchically organized into the first program for exchanging information with the device and the second program for exchanging information with the first program, and the second program generates abstracted information by abstracting the information received from the first program, and performs information processing on the basis of the abstracted information; thus, even when a change is made, for example, in a format of information exchanged between the first program and the second program, it is only necessary to make a change only to the part of the second program for generating abstracted information, thereby making is possible to suppress increases in program development period and development cost, for example. Further, the second program exclusive of the part for generating abstracted information, i.e., the part for performing main information processing, can be developed independently of the first program, and therefore, facilitation and speed-up of development of the second program can be realized.

Furthermore, in the present invention, the device control program is structured so that the first program group includes one or a plurality of the first programs, and the second program group includes a plurality of the second programs and the shared program for, for example, storing information shared by a plurality of the second programs, and for performing information processing on this information; thus, it is unnecessary for a plurality of the second programs to store the same information, and it is unnecessary for a plurality of the second programs to perform the same information processing, thereby making it possible to save memory resources of the apparatus that executes the device control program, and to enhance the processing speed thereof.

Moreover, in the present invention, the second program associated with the device includes the basic program portion concerning a function common to different devices, and the unique program portion concerning a different function; thus, program resources of the second program can be effectively reutilized, and therefore, reductions in development period and development cost of the device control program can be achieved with more reliability.

The above and further objects and features will more fully be apparent from the following detailed description with accompanying drawings.

### BRIEF DESCRIPTION OF THE SEVERAL VIEWS OF THE DRAWINGS

FIG. 1 is a block diagram illustrating a configuration of an in-vehicle device control apparatus according to an embodiment of the present invention.

FIG. 2 is a schematic diagram for describing a structure of an in-vehicle device control program according to the embodiment of the present invention.

FIG. 3 is a schematic diagram for describing a structure of a program of an application program.

FIG. 4 is a flow chart illustrating processing steps performed by the program of the application layer.

FIG. 5 is a schematic diagram illustrating an example of processing performed by the program of the application layer.

FIG. 6 is a schematic diagram illustrating the example of processing performed by the program of the application layer.

FIG. 7 is a schematic diagram for describing a structure of an in-vehicle device control program according to Embodiment 2 of the present invention.

FIG. 8 is a schematic diagram illustrating examples of pieces of information stored by the respective programs of the application layer.

FIG. 9 is a schematic diagram for describing a structure of an in-vehicle device control program according to Embodiment 3 of the present invention.

FIG. 10 is a schematic diagram for describing a structure of an in-vehicle device control program according to a variation of Embodiment 3 of the present invention.

FIG. 11 is a schematic diagram for describing a structure of an in-vehicle device control program according to Embodiment 4 of the present invention.

### DETAILED DESCRIPTION

### Embodiment 1

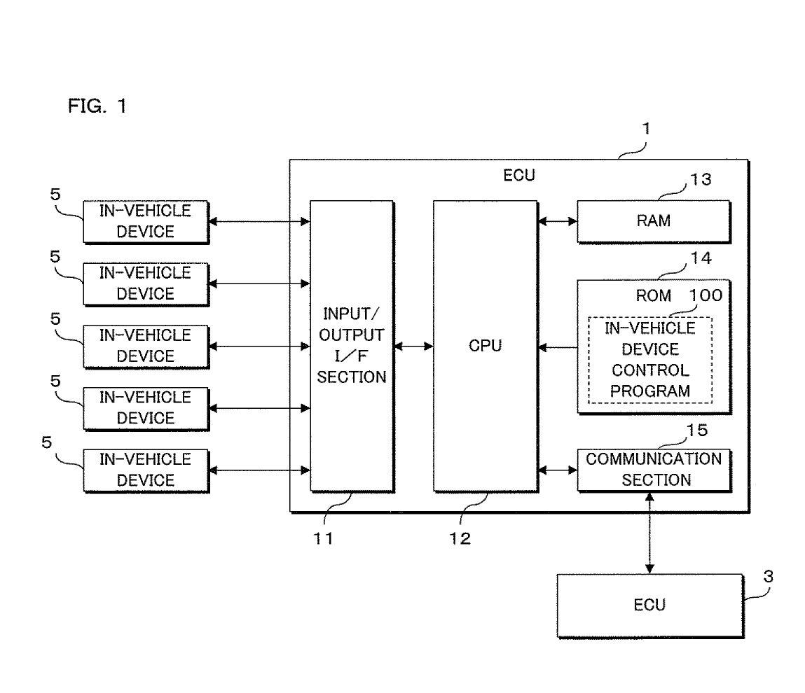

Hereinafter, the present invention will be specifically described with reference to the drawings illustrating embodiments thereof. It should be noted that in the present embodiment, an in-vehicle device control apparatus for controlling various devices installed in a vehicle will be described by way of example. FIG. 1 is a block diagram illustrating a configuration of an in-vehicle device control apparatus according to the embodiment of the present invention. In this diagram, the reference numeral 1 represents an ECU (Electronic Control Unit) that controls a plurality of in-vehicle devices 5 installed in an unillustrated vehicle, and that is equivalent to a device control apparatus according to the present invention. The ECU 1 includes an input/output I/F (interface) section 11 connected via communication cables or the like to the plurality of in-vehicle devices 5, and the input/output I/F section 11 is allowed to exchange information with each in-vehicle device 5.

The ECU 1 further includes a CPU (Central Processing Unit) 12 for performing various arithmetic processes, control processes, etc. on respective sections in the ECU 1. Through the input/output I/F section 11, information from each in-vehicle device 5 is supplied to the CPU 12, and information from the CPU 12 is supplied to each in-vehicle device 5. The CPU 12 is capable of performing arithmetic processes, control processes, etc. by reading and executing an in-vehicle device control program 100 stored in advance in a ROM (Read Only Memory) 14, and advances the processes while storing temporary data, generated in the course of the processes, in a RAM (Random Access Memory) 13.

The ECU 1 performs information processing concerning information supplied from each in-vehicle device 5 by executing the in-vehicle device control program 100 by the CPU 12, and can carry out control of each in-vehicle device 5 by supplying a processing result to each in-vehicle device 5. The ECU 1 further includes a communication section 15, and the communication section 15 exchanges information with an other ECU 3, thereby making is possible to obtain information from the other in-vehicle device connected to the other ECU 3, and to carry out control of the other in-vehicle device.

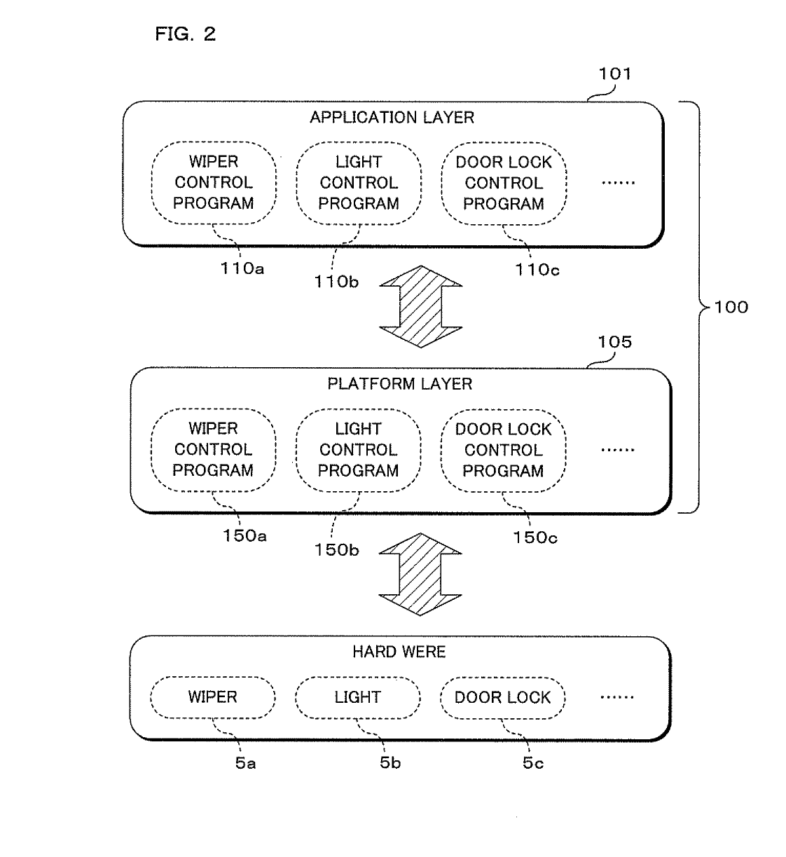

FIG. 2 is a schematic diagram for describing a structure of the in-vehicle device control program 100 according to the embodiment of the present invention. For example, as hardware controlled by the in-vehicle device control program 100, in-vehicle devices such as a wiper 5a, a light 5b and a door lock 5c are installed in the vehicle. The in-vehicle device control program 100 includes a two-level hierarchy having a platform layer (first program group) 105 and an application layer (second program group) 101, and each of these layers includes a plurality of programs.

The platform layer 105, for example, includes a plurality of programs (first programs) such as a wiper control program 150a, a light control program 150b and a door lock control program 150c. The CPU 12 of the ECU 1 operates as a first processing section by executing the first programs of the platform layer 105. The programs of the platform layer 105 (i.e., the CPU 12 that executes the programs of the platform layer 105) can exchange information with the in-vehicle devices 5, and can exchange information with the application layer 101. In other words, the programs of the platform layer 105 each perform a process for converting (or abstracting) information, supplied from the associated in-vehicle device 5, into an information format suitable for the application layer 101 and for supplying the resulting information to the application layer 101, or a process for supplying control information to the associated in-vehicle device 5 in accordance with control-related information supplied from the application layer 101, thereby controlling an operation of this in-vehicle device 5.

For example, on the basis of control information for turning the wiper 5a ON/OFF or control information for allowing a high speed operation/intermittent operation, etc., supplied from the application layer 101, the wiper control program 150a of the platform layer 105 can operate the wiper 5a by supplying, with a predetermined timing, a driving signal as control information to a motor or an actuator, for example, which operates the wiper 5a. Furthermore, for example, when a raindrop sensor (not illustrated) is installed as the in-vehicle device 5 in the vehicle, the program of the platform layer 105 (which is a program for controlling the raindrop sensor) converts a voltage value or the like, supplied as a detection result from the raindrop sensor, into information having a predetermined format, and supplies the resulting information to the program of the application layer 101.

The application layer 101, for example, includes a plurality of programs (second programs) such as a wiper control program 110a, a light control program 110b and a door lock control program 110c. The CPU 12 of the ECU 1 operates as a second processing section by executing the second programs of the application layer 101. The programs of the application layer 101 (i.e., the CPU 12 that executes the programs of the application layer 101) can exchange information with the platform layer 105. The programs of the application layer 101 each perform information processing concerning control of the in-vehicle device 5 on the basis of information supplied from the platform layer 105, and perform a process for supplying a processing result to the platform layer 105.

In other words, the device control apparatus is configured so that information from the in-vehicle device 5 is converted into a suitable information format and supplied to the application layer 101 by the platform layer 105, the application layer 101 performs information processing concerning the control of the in-vehicle device 5 on the basis of the supplied information, and the platform layer 105 controls the in-vehicle device 5 in accordance with the processing result.

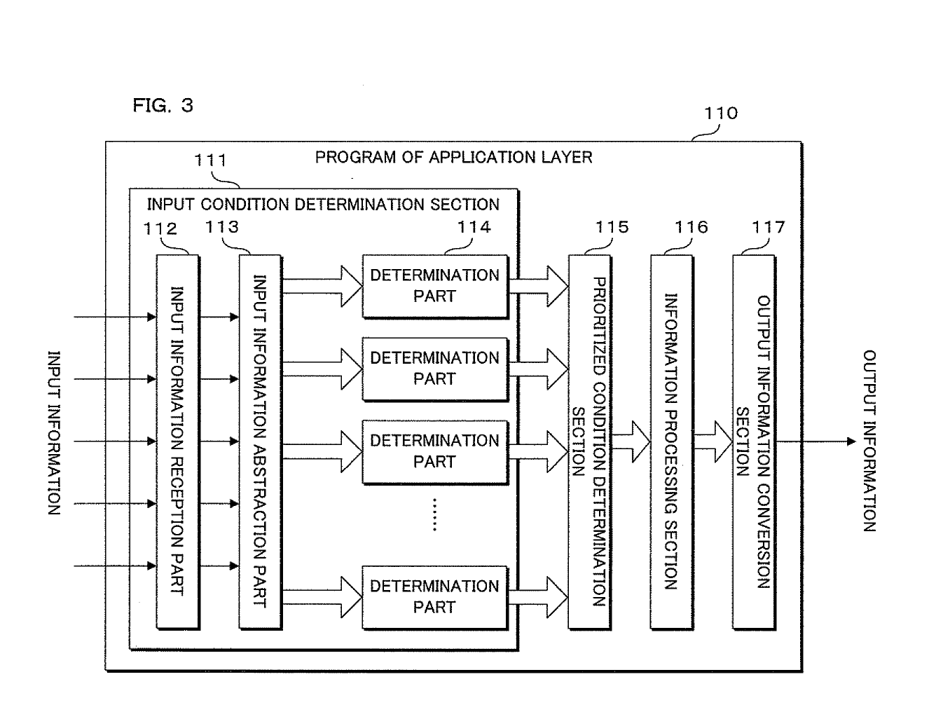

FIG. 3 is a schematic diagram for describing a structure of a program 110 of the application layer 101, and illustrates a structure of each of the programs such as the wiper control program 110a, the light control program 110b and the door lock control program 110c of the application layer 101 illustrated in FIG. 2. The program 110 of the application layer 101 includes an input condition determination section 111 for determining a condition for controlling the associated in-vehicle device 5 on the basis of a plurality of pieces of information (input information) supplied from the platform layer 105. Further, the input condition determination section 111 includes an input information reception part 112, an input information abstraction part 113 and determination parts 114. Input information from the platform layer 105 is received by the input information reception part 112. The input information reception part 112 stores the received input information and supplies the received input information to the input information abstraction part 113 as necessary.

The input information abstraction part 113 determines whether or not a predetermined condition is satisfied by a plurality of pieces of the supplied input information, and abstracts the input information based on a determination result. For instance, it is determined whether or not a predetermined condition is satisfied by the input information such as information on a state of a vehicle ignition switch and information on an engine state, and based on a determination result, the input information abstraction part 113 can abstract information for the power for supply of power to the in-vehicle device 5 as follows, for example: “power is ON” or “power is OFF”. Furthermore, for instance, it is determined whether or not a predetermined condition is satisfied by the input information such as information on whether or not a sensor for detecting a raindrop is installed in the vehicle or information on whether or not the raindrop sensor is operating normally, and a detection result obtained by the raindrop sensor, and the input information abstraction part 113 can abstract the information as follows, for example: “it is raining” or “it is not raining”. The input information abstraction part 113 supplies the abstracted information to a plurality of the determination parts 114. It should be noted that in FIG. 3, the abstracted information, which is given and received, is indicated by hollow thick arrows, and information, which is not abstracted, is indicated by black thin arrows.

The input condition determination section 111 is provided with a plurality of the determination parts 114, each of which determines whether or not a predetermined condition is satisfied by the abstracted information, and notifies a prioritized condition determination section 115 of a determination result when it is determined that the condition is satisfied. Conditions determined by the respective determination parts 114 are different from each other. For example, the determination parts 114 are capable of determining whether or not requirements such as information that “power is ON”, information that “it is raining heavily” and information that “an auto-wiper function is operable” are satisfied, and capable of notifying the prioritized condition determination section 115 of satisfaction of a condition for a “high speed wiper operation”.

Upon notification of satisfaction of conditions from a plurality of the determination parts 114, the prioritized condition determination section 115 is allowed to determine which condition has the highest priority, and to supply the highest-priority condition, obtained as a determination result, to an information processing section 116. For example, when the condition for the “high speed wiper operation” and condition for “intermittent wiper operation” are satisfied, the prioritized condition determination section 115 is allowed to determine that the condition for the “high speed wiper operation” has a higher priority, and to supply this condition to the information processing section 116. It should be noted that the priorities of the respective conditions may be set in advance and may be stored as a table or the like in the prioritized condition determination section 115.

In accordance with the condition supplied from the prioritized condition determination section 115, the information processing section 116 performs information processing for controlling the in-vehicle device 5, and supplies control information, generated as an information processing result, to an output information conversion section 117. For example, when the condition for the “high speed wiper operation” is supplied, the information processing section 116 can perform a process for generating control information for “causing the wiper to operate at a high speed” in order to operate the wiper 5a at a high speed, and can supply the generated control information to the output information conversion section 117.

The output information conversion section 117 converts the control information, supplied from the information processing section 116, into an information format suitable for the platform layer 105, and supplies the resulting information to the platform layer 105. In other words, the output information conversion section 117 performs a process for returning the information, abstracted by the input information abstraction part 113, to its original format. For example, when the control information for “causing the wiper to operate at a high speed” is supplied, the output information conversion section 117 can convert this control information into, for example, information for turning ON the wiper 5a and numerical information by which an operation speed of the wiper 5a is set, and can supply the resulting information to the platform layer 105.

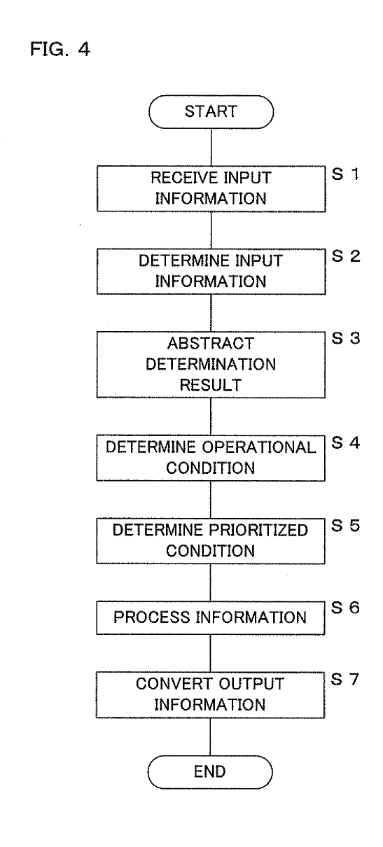

FIG. 4 is a flow chart illustrating processing steps performed by the program 110 of the application layer 101, which are executed by reading the in-vehicle device control program 100 by the CPU 12 of the ECU 1 serving as the in-vehicle device control apparatus. First, the program 110 of the application layer 101 receives, through the input information reception part 112, input information from the platform layer 105 (Step S1). Subsequently, the program 110 of the application layer 101 determines whether or not the received input information satisfies a predetermined condition (Step S2) and abstracts the input information based on a determination result (Step S3) by the input information abstraction part 113.

After the abstraction of the input information, the program 110 of the application layer 101 determines whether or not the abstracted information satisfies predetermined operational conditions by the determination parts 114 (Step S4), and further determines a condition having the highest priority from among a plurality of the satisfied conditions by the prioritized condition determination section 115 (Step S5). Then, the program 110 of the application layer 101 performs, by the information processing section 116, information processing for controlling the in-vehicle device 5 in accordance with the highest-priority condition (Step S6), thereby generating control information for controlling the in-vehicle device 5. Thereafter, the program 110 of the application layer 101 converts the control information, generated as output information by the information processing section 116, into a format suitable for the platform layer 105 (Step S7), and supplies the converted control information to the platform layer 105, thus ending the procedure.

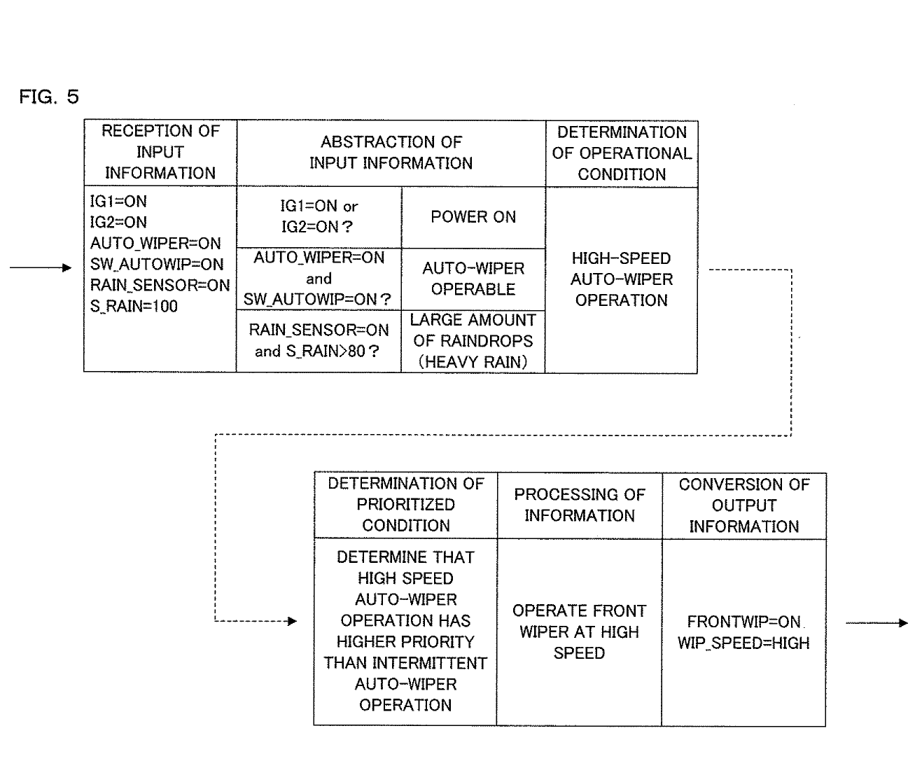

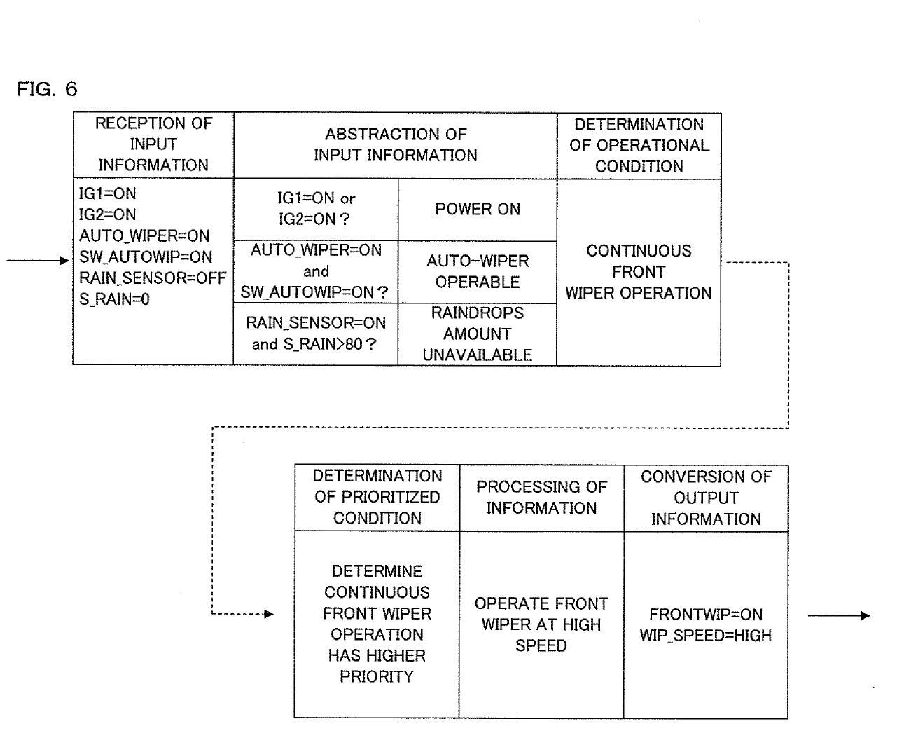

FIGS. 5 and 6 are schematic diagrams illustrating an example of processing performed by the program 110 of the application layer 101. It should be noted that the present example is one in which when the auto-wiper function of automatically operating the wiper 5a by detecting a rainfall is installed in the vehicle, the program 110 of the application layer 101 performs processing concerning this auto-wiper function. Processes performed in the platform layer 105 include: a process for converting an output voltage or the like of the raindrop sensor into a numerical value such as an amount of rainfall; a process for operating the wiper 5a by outputting a driving signal or the like; a process for detecting an operational state of a switch or the like for making a setting for enabling/disabling an operation of the wiper 5a; a process for detecting an operational state of the vehicle ignition switch; and a process for detecting an operating state of the vehicle engine.

Further, in the present example, the platform layer 105 supplies, to the application layer 101, the following six pieces of information: “IG1”; “IG2”; “AUTO_WIPER”; “SW_AUTOWIP”; “RAIN_SENSOR”; and “S_RAIN” “IG1” is information which indicates the operational state of the ignition switch, and to which “ON” or “OFF” is set. “IG2” is information which indicates the operating state of the vehicle engine, and to which “ON” or “OFF” is set. “AUTO_WIPER” is information which indicates whether or not the auto-wiper function is installed in the vehicle, and to which “ON” or “OFF” is set. “SW_AUTOWIP” is information which indicates the operational state of the switch for setting ON/OFF of the auto-wiper function, and to which “ON” or “OFF” is set. “RAIN_SENSOR” is information which indicates whether or not the raindrop sensor is operating normally, and to which “ON” is set when the raindrop sensor is operating normally but “OFF” is set when the raindrop sensor is operating abnormally at the time of trouble, for example. Furthermore, “S_RAIN” is information which indicates a detection value obtained by the raindrop sensor, and to which a numerical value of 0 to 200 is set.

The program 110 of the application layer 101 receives the above-described six pieces of information by the input information reception part 112. Hereinafter, the description is made based on the assumption that the input information reception part 112 has received the following information by way of example: “IG1=ON”; “IG2=ON”; “AUTO_WIPER=ON”; “SW_AUTOWIP=ON”; “RAIN_SENSOR=ON”; and “S_RAIN=100” (see FIG. 5). The input information abstraction part 113 makes determinations on the following three conditions: whether or not “IG1=ON” or “IG2=ON” holds (first condition); whether or not “AUTO_WIPER=ON” and “SW_AUTOWIP=ON” hold (second condition); and whether or not “RAIN_SENSOR=ON” and “S_RAIN>80” hold (third condition), and abstracts the six pieces of input information based on determination results, thereby generating three pieces of abstracted information. The input information abstraction part 113 generates “power ON” as the abstracted information when the foregoing first condition holds, generates “auto-wiper operable” as the abstracted information when the second condition holds, and generates “large amount of raindrops (heavy rain)” as the abstracted information when the third condition holds.

The determination parts 114 are each allowed to determine whether or not the foregoing abstracted information satisfies a predetermined condition. In the present example, the determination part 114 for determining a condition for a “high speed auto-wiper operation” for operating the wiper 5a at a high speed as the auto-wiper function determines that the condition is satisfied, and the prioritized condition determination section 115 is notified of this determination. Furthermore, in the present example, the determination part 114 for determining a condition for an “intermittent auto-wiper operation” for operating the wiper 5a intermittently as the auto-wiper function may also determine that the condition is satisfied.

When both of the conditions for the “high speed auto-wiper operation” and “intermittent auto-wiper operation” are determined to be satisfied, the prioritized condition determination section 115 determines that the condition for the “high speed auto-wiper operation” has a higher priority, and supplies this condition to the information processing section 116. The information processing section 116 generates control information for “operating a front wiper at a high speed” for a high speed operation of the vehicle's front wiper 5a corresponding to the auto-wiper function, and supplies the control information to the output information conversion section 117. The output information conversion section 117 converts the supplied control information for “operating the front wiper at a high speed” into an information format for the platform layer 105; for example, the output information conversion section 117 converts the supplied control information into information such as “FRONTWIP=ON” and “WIP_SPEED=HIGH”, and supplies the converted information to the platform layer 105. It should be noted that “FRONTWIP” is information which indicates whether or not the front wiper 5a should be operated, and to which “ON” or “OFF” is set. “WIP_SPEED” is information which indicates an operation speed of the wiper 5a, and to which “HIGH”, “LOW” or numerical value, for example, is set.

The platform layer 105, to which the information such as “FRONTWIP=ON” and “WIP_SPEED=HIGH” has been supplied from the application layer 101, generates, for example, a driving signal for allowing a high speed operation of the front wiper 5a and supplies the signal to the wiper 5a by the wiper control program 150a. Thus, the ECU 1 can detect an amount of rainfall and can automatically operate the wiper 5a at an appropriate speed.

The following description is made based on the assumption that trouble has occurred in the raindrop sensor of the vehicle afterwards, and the input information reception part 112 has received the following information: “IG1=ON”; “AUTO_WIPER=ON”; “SW_AUTOWIP=ON”, “RAIN_SENSOR=OFF”; and “S_RAIN=0” (see FIG. 6). The input information abstraction part 113 makes determinations on the foregoing first to third conditions to generate abstracted information. In this case, since the first and second conditions hold, the input information abstraction part 113 generates “power ON” and “auto-wiper operable” as the abstracted information similarly to the case illustrated in FIG. 5. However, the third condition does not hold because of “RAIN_SENSOR=OFF”, and therefore, the input information abstraction part 113 generates “raindrop amount unavailable” as the abstracted information.

The determination parts 114 each make a determination on the basis of the abstracted information. In this case, since “power ON”, “auto-wiper operable” and “raindrop amount unavailable” are satisfied, the determination part 114 for determining a condition for a “continuous front wiper operation” determines that the condition is satisfied, and the prioritized condition determination section 115 is notified of this determination. The prioritized condition determination section 115 determines that the condition for the “continuous front wiper operation” has a higher priority, and supplies this condition to the information processing section 116.

The information processing section 116, to which the condition for the “continuous front wiper operation” has been supplied, checks the operating state of the wiper 5a preceding the supply of this condition, and generates control information so as to continue this operating state. For example, when the wiper 5a has been operated at a high speed before the supply of this condition, the information processing section 116 generates the control information for “operating the front wiper at a high speed” and supplies the control information to the output information conversion section 117 so as to continue the high speed operation of the wiper 5a. Similarly to the case illustrated in FIG. 5, the output information conversion section 117 converts the supplied control information for “operating the front wiper at a high speed” into information such as “FRONTWIP=ON” and “WIP_SPEED=HIGH”, and supplies the converted information to the platform layer 105. Thus, the high speed operation of the wiper 5a is continuously carried out by the wiper control program 150a of the platform layer 105.

The in-vehicle device control apparatus (ECU 1) provided as described above is configured so that the in-vehicle device control program 100 for controlling the in-vehicle devices 5 includes a hierarchical structure having the platform layer 105 and the application layer 101, and the program 110 of the application layer 101 abstracts, using the input information abstraction part 113, information supplied from the platform layer 105; then, for example, determinations are made by the determination parts 114 and the prioritized condition determination section 115, and information processing is performed by the information processing section 116. Thus, when a change is made to the information supplied to the application layer 101 from the platform layer 105, it is only necessary to make changes only to the input information reception part 112 and the input information abstraction part 113, and no change has to be made to the information processing section 116 and the like. For instance, when information of “IG2” supplied from the platform layer 105 is deleted, the condition for generating “power ON” as abstracted information by the input information abstraction part 113 may be changed to only “IG1=ON”, for example.

Furthermore, the in-vehicle device control apparatus is configured so that the information processing section 116 performs information processing using the abstracted information, and the output information conversion section 117 converts a result of this information processing into an information format suitable for the platform layer 105; thus, when a change is made to the information supplied to the platform layer 105 from the application layer 101, it is only necessary to make a change only to the output information conversion section 117, and no change has to be made to the information processing section 116 and the like. For instance, when a change is made to the format of the information supplied to the platform layer 105 in order to operate the front wiper 5a at a high speed, the information converted by the output information conversion section 117 may be changed from the two pieces of information “FRONTWIP=ON” and “WIP_SPEED=HIGH” to the single piece of information “FRONTWIP_HIGH=ON”, for example.

It should be noted that although the control of the wiper 5a serving as the in-vehicle device 5 has been mainly described in the present embodiment, the same goes for the other in-vehicle devices 5, and therefore, detailed description thereof will be omitted. Besides, the input information, conditions to be determined, abstracted information, control information, etc., illustrated in FIGS. 5 and 6, are provided by way of example, and the present invention is not limited thereto.

### Embodiment 2

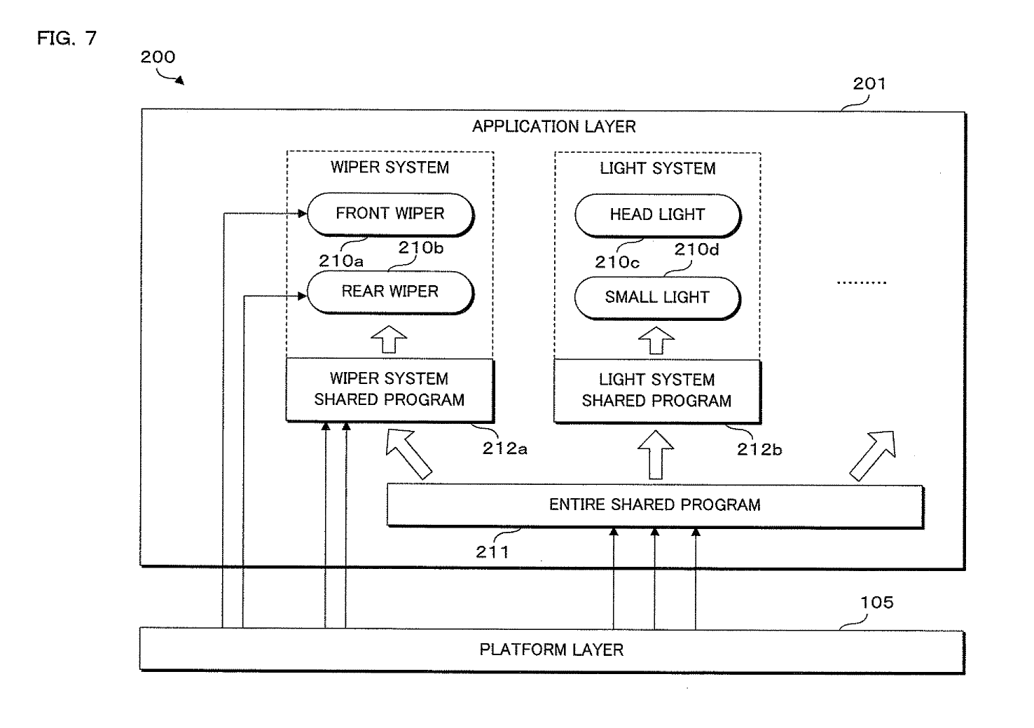

FIG. 7 is a schematic diagram for describing a structure of an in-vehicle device control program 200 according to Embodiment 2 of the present invention. The in-vehicle device control program 200 according to Embodiment 2 includes a two-level hierarchy having a platform layer 105 and an application layer 201, and each of these layers includes a plurality of programs.

The application layer 201 includes a plurality of programs (second programs, second processing sections) such as a front wiper control program (which is simply represented as “front wiper” in FIG. 7 [the same goes for the following programs]) 210a, a rear wiper control program 210b, a headlight control program 210c and a small light control program 210d, for example. In addition, the application layer 201 of Embodiment 2 groups the programs into a wiper system and a light system, for example, and further includes: a wiper system shared program 212a, a light system shared program 212b, etc. for, for example, storage and processing of information common to the programs within the respective groups; and an entire shared program (shared processing section) 211 for, for example, storage and processing of information common to all the programs of the application layer 201.

The entire shared program 211 receives and stores information provided from the platform layer 105, and abstracts the received information to supply the abstracted information to the other programs of the application layer 201. The wiper system shared program 212a receives and stores information provided from the platform layer 105, and receives the abstracted information provided from the entire shared program 211. The wiper system shared program 212a utilizes, as necessary, the abstracted information from the entire shared program 211 to abstract the information provided from the platform layer 105, and supplies the abstracted information to the programs such as the front wiper control program 210a and the rear wiper control program 210b, which are grouped into the wiper system. Besides, the light system shared program 212b also performs similar processes.

The front wiper control program 210a receives and stores information provided from the platform layer 105, and receives the abstracted information provided from the entire shared program 211 and the wiper system shared program 212a. The front wiper control program 210a utilizes, as necessary, the abstracted information from the entire shared program 211 and the wiper system shared program 212a to abstract the information provided from the platform layer 105. Then, the front wiper control program 210a performs information processing concerning the control of the front wiper on the basis of: the abstracted information; and the abstracted information received from the entire shared program 211 and the wiper system shared program 212a. In addition, the rear wiper control program 210b, the headlight control program 210c, the small light control program 210d, etc. also perform similar processes.

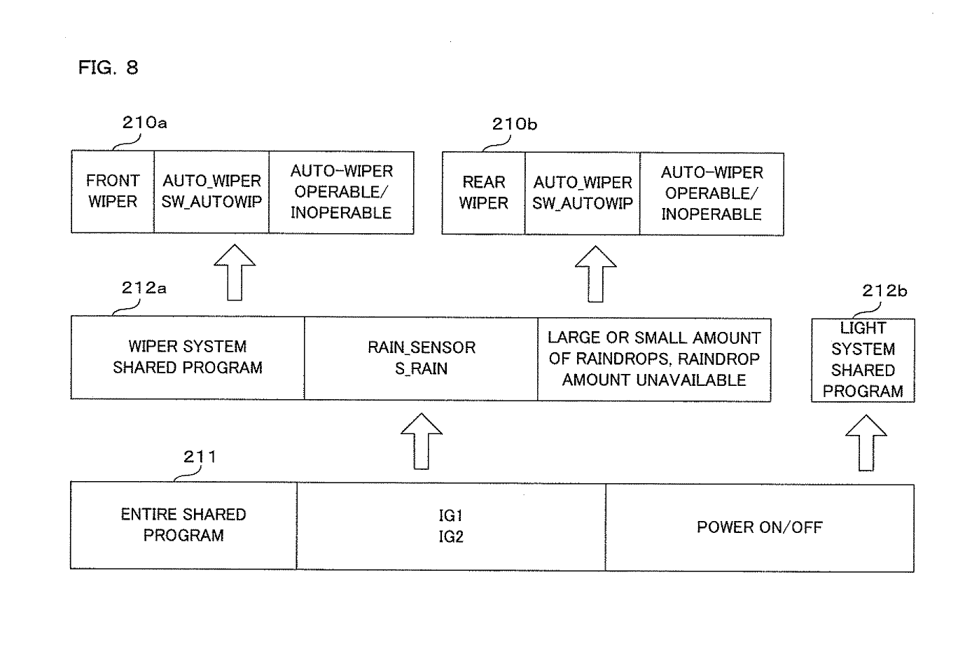

FIG. 8 is a schematic diagram illustrating examples of pieces of information stored by the respective programs of the application layer 201. It should be noted that, referring to FIG. 8, six pieces of information such as “IG1”, “IG2”, “AUTO_WIPER”, “SW_AUTOWIP”, “RAIN_SENSOR” and “S_RAIN” are supplied from the platform layer 105 to the application layer 201 similarly to FIGS. 5 and 6, and attention is given to information utilized by the programs of the wiper system so that information stored and abstracted by the respective programs is presented.

The information “IG1” and “IG2” supplied from the platform layer 105 is information concerning a power state of a vehicle, and is information necessary not only for the programs of the wiper system but also for the other programs. Hence, the entire shared program 211 receives the information “IG1” and “IG2” from the platform layer 105, stores the received information, abstracts the received information, and supplies the abstracted information such as “power ON” or “power OFF” to the other programs of the application layer 201. It should be noted that it is only necessary for the entire shared program 211 to have the input information reception part 112 and the input information abstraction part 113 illustrated in FIG. 3, but may alternatively be structured to further have the determination parts 114, the prioritized condition determination section 115, the information processing section 116, the output information conversion section 117, etc. so as to perform information processing for controlling the in-vehicle device 5 concerning the power.

The information “RAIN_SENSOR” and “S_RAIN” supplied from the platform layer 105 is information concerning a raindrop sensor, and is information necessary for the programs of the wiper system to implement an auto-wiper function. Hence, the wiper system shared program 212a receives and stores the information “RAIN_SENSOR” and “S_RAIN”, abstracts the received information, and supplies the abstracted information such as “large amount of raindrops”, “small amount of raindrops” or “raindrop amount unavailable” to the front wiper control program 210a and the rear wiper control program 210b. It should be noted that it is only necessary for the wiper system shared program 212a to have the input information reception part 112 and the input information abstraction part 113 similarly to the entire shared program 211, but may alternatively be structured to further have the determination parts 114, the prioritized condition determination section 115, the information processing section 116, the output information conversion section 117, etc. so as to perform information processing for controlling the raindrop sensor.

The information “AUTO_WIPER” and “SW_AUTOWIP” supplied from the platform layer 105 is information concerning the auto-wiper function. The auto-wiper function may be provided only in the front wiper or may be provided in both of the front wiper and the rear wiper, and therefore, the information concerning the auto-wiper function is separately supplied to the front wiper control program 210a and the rear wiper control program 210b (in other words, the information “AUTO_WIPER” and “SW_AUTOWIP” for the front wiper, and the information “AUTO_WIPER” and “SW_AUTOWIP” for the rear wiper are supplied as different pieces of information having different values from the platform layer 105). The front wiper control program 210a and the rear wiper control program 210b receive “AUTO_WIPER” and “SW_AUTOWIP” from the platform layer 105, store the received information, abstract the received information, receive the information abstracted by the entire shared program 211 and the wiper system shared program 212a, and perform information processing concerning the control of the front wiper and rear wiper on the basis of these pieces of abstracted information.

The in-vehicle device control program 200 according to Embodiment 2 provided as described above is structured so that the information utilized by all the programs of the application layer 201 is stored and abstracted by the entire shared program 211, the programs are grouped into the wiper system and the light system, for example, and the information utilized by the programs in the groups is stored and abstracted by the wiper system shared program 212a and the light system shared program 212b, for example; thus, it is unnecessary for the respective programs of the application layer 201 to store and abstract the same information, thereby making it possible to save memory resources of the device control apparatus, and to enhance the processing speed thereof.

It should be noted that although the application layer 201 is structured to include the entire shared program 211, the wiper system shared program 212a and the light system shared program 212b in Embodiment 2, the present invention is not limited thereto. Alternatively, the application layer 201 may be structured to include no entire shared program 211 and include only the wiper system shared program 212a and the light system shared program 212b, or may be structured to include no wiper system shared program 212a nor light system shared program 212b and include only the entire shared program 211, and no limitation is imposed on a combination of theses programs. Further, the application layer 201 may be structured to further include a multi-group-shared program for storing and processing information that is not common to the entire application layer 201 but common to some of the limited groups such as the wiper system and the light system.

Furthermore, the application layer is structured so that the entire shared program 211, the wiper system shared program 212a and the light system shared program 212b store and abstract the information provided from the platform layer 105, but the present invention is not limited thereto; alternatively, the application layer may be structured so that these programs only store the information provided from the platform layer 105, and information abstraction is performed by the respective programs such as the front wiper control program 210a, the rear wiper control program 210b, the headlight control program 210c and the small light control program 210d.

It should be noted that since other features of the in-vehicle device control apparatus and in-vehicle device control program according to Embodiment 2 are similar to those of the in-vehicle device control apparatus and in-vehicle device control program according to Embodiment 1, similar elements are identified by the same reference characters, and detailed description thereof will be omitted.

### Embodiment 3

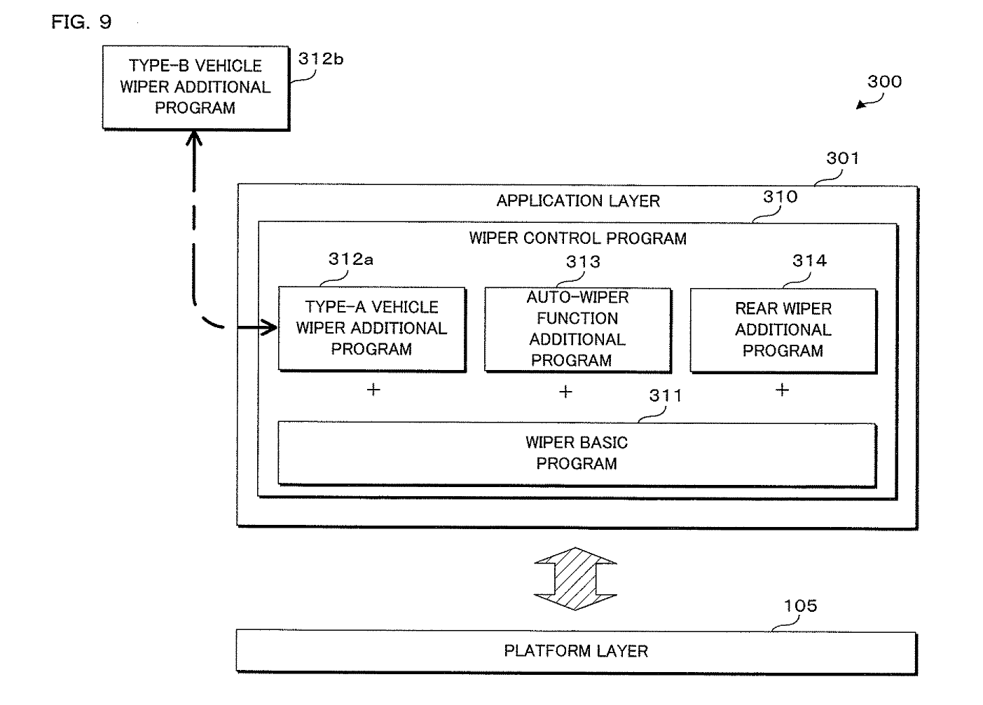

FIG. 9 is a schematic diagram for describing a structure of an in-vehicle device control program 300 according to Embodiment 3 of the present invention. Each program included in an application layer 301 of the in-vehicle device control program 300 according to Embodiment 3 includes a combination of a basic program (basic processing part) and an additional program (unique program, unique processing part). It should be noted that, of those included in the application layer 301, a structure of a wiper control program 310 is illustrated and other programs such as a light control program and a door lock control program are not illustrated in FIG. 9.

The wiper control program 310 of the application layer 301 includes a combination of: a wiper basic program 311; a type-A vehicle wiper additional program 312a; an auto-wiper function additional program 313; and a rear wiper additional program 314. The wiper basic program 311 is a program for, for example, storing and processing information concerning a basic function common to different types of wipers such as front and rear wipers of a vehicle, or to various wipers such as ones with different specifications, installed in different vehicle types such as type-A and type-B vehicles. Examples of the function common to various wipers include the function of turning ON/OFF a wiper operation based on a switch operation performed by a user, or the function of determining power ON/OFF based on information such as “IG1” and “IG2” supplied from the platform layer 105. Similarly to the entire shared program 211 of Embodiment 2, the wiper basic program 311 may be structured to have only the input information reception part 112 and the input information abstraction part 113, or may be structured to further have the determination parts 114, the prioritized condition determination section 115, the information processing section 116, the output information conversion section 117, etc.

The type-A vehicle wiper additional program 312a is a program for, for example, storing and processing information concerning a function unique to the wiper installed in the vehicle of a vehicle type A. Wipers to be installed in vehicles include one capable of changing an operation speed in multiple steps, for example, for each vehicle type, and one incapable of doing so, and therefore, operation details, specifications or the like of the wipers are slightly different from each other. Hence, when the wiper control program 310 is diverted for the vehicle type A and vehicle type B, for example, the type-A vehicle wiper additional program 312a for performing processing concerning a function unique to the vehicle type A, and a type-B vehicle wiper additional program 312b for performing processing concerning a function unique to the vehicle type B are created, and either one of the programs is incorporated into the wiper control program 310 in accordance with the vehicle type of a vehicle in which a wiper is to be installed.

The auto-wiper function additional program 313 is a program for, for example, storing and processing information unique to the auto-wiper function that automatically operates the wiper in accordance with the amount of raindrops detected by the raindrop sensor, and is incorporated into only the wiper control program 310 of the vehicle in which the wiper having the auto-wiper function is installed. Further, the rear wiper additional program 314 is a program for, for example, storing and processing information unique to operation control of the vehicle's rear wiper, and is incorporated into only the wiper control program 310 of the vehicle in which the rear wiper is installed.

It should be noted that a detailed structure of each of the type-A vehicle wiper additional program 312a, the type-B vehicle wiper addition program 312b, the auto-wiper function additional program 313, the rear wiper additional program 314, etc. may be similar to that of the program 110 of the application layer illustrated in FIG. 3.

The in-vehicle device control program 300 according to Embodiment 3 provided as described above is structured so that the programs of the application layer 301 are classified into different programs (program portions) on a function-by-function basis and a plurality of the programs are combined in accordance with the function of the in-vehicle device 5 to be controlled; thus, reusability of the programs of the application layer 301 can be increased, and reductions in program development period and development cost, for example, can be realized. It should be noted that the structure of the wiper control program 310 illustrated in FIG. 9 is presented by way of example, and an alternative structure such as one described in the following variation may also be applicable.

(Variation)

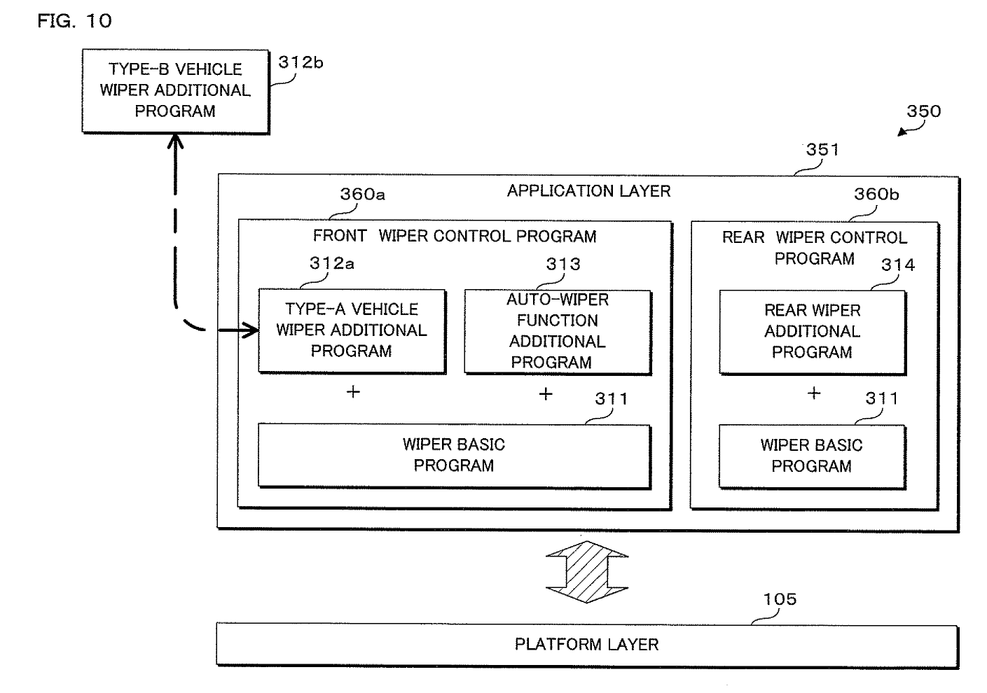

FIG. 10 is a schematic diagram for describing a structure of an in-vehicle device control program 350 according to a variation of Embodiment 3 of the present invention. An application layer 351 of the in-vehicle device control program 350 according to the variation includes a front wiper control program 360a and a rear wiper control program 360b as programs for controlling wipers of a vehicle. The front wiper control program 360a includes a combination of a wiper basic program 311, a type-A vehicle wiper additional program 312a and an auto-wiper function additional program 313. Further, the rear wiper control program 360b includes a combination of a wiper basic program 311 and a rear wiper additional program 314.

It should be noted that since other features of the in-vehicle device control apparatus and in-vehicle device control program according to Embodiment 3 are similar to those of the in-vehicle device control apparatus and in-vehicle device control program according to Embodiment 1, similar elements are identified by the same reference characters, and detailed description thereof will be omitted.

### Embodiment 4

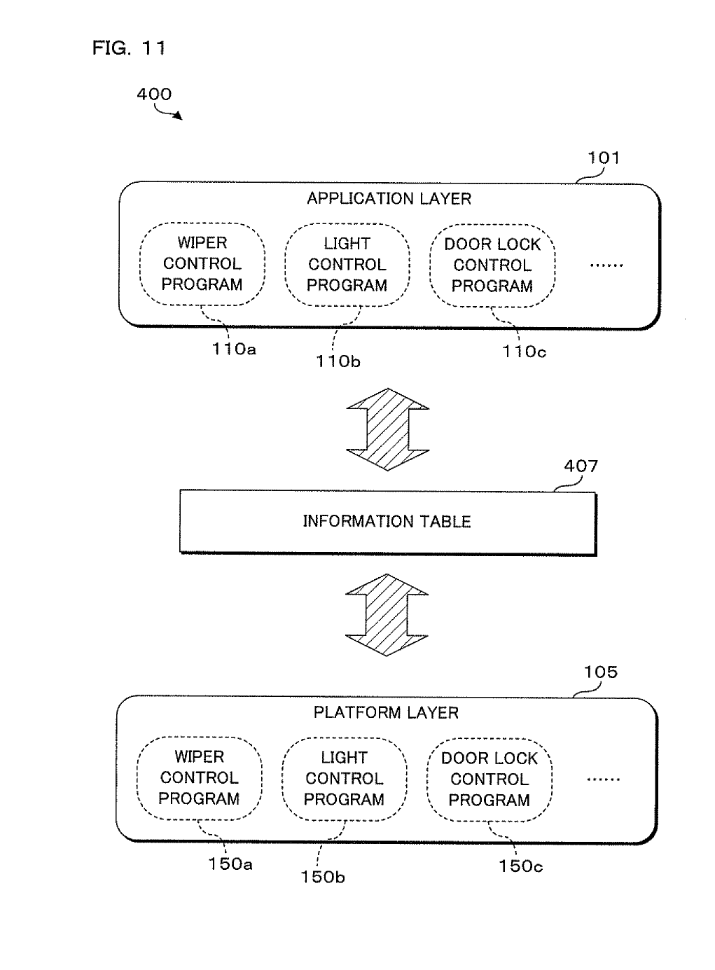

FIG. 11 is a schematic diagram for describing a structure of an in-vehicle device control program 400 according to Embodiment 4 of the present invention. The in-vehicle device control program 400 according to Embodiment 4 includes a two-level hierarchy having a platform layer 105 and an application layer 101, and is structured to exchange information between programs of the platform layer 105 and those of the application layer 101 via an information table 407. It should be noted that the programs of the platform layer 105 and those of the application layer 101 are not allowed to directly exchange information.

The information table 407 is a storage region capable of storing only information determined in advance, and is implemented, for example, by a RAM 13 of an ECU 1 or a register of a CPU 12. The programs of the platform layer 105 store, in the information table 407, information to be supplied to the application layer 101, and read and acquire, from the information table 407, information provided from the application layer 101.

Similarly, the programs of the application layer 101 store, in the information table 407, information to be supplied to the platform layer 105, and read and acquire, from the information table 407, information provided from the platform layer 105. It should be noted that a program 110 of the application layer 101 may be structured so that an input information reception part 112 reads information from the information table 407, and an output information conversion section 117 stores information in the information table 407.

The in-vehicle device control program 400 according to Embodiment 4 provided as described above is structured so that the programs of the platform layer 105 and those of the application layer 101 exchange information via the information table 407, thus making it possible to limit information supplied from the platform layer 105 to the application layer 101 and information supplied from the application layer 101 to the platform layer 105; therefore, invalid information access from the application layer 101 to the platform layer 105 can be prevented, and invalid information access from the platform layer 105 to the application layer 101 can be prevented, thereby increasing reliability of the in-vehicle device control program 400.

It should be noted that since other features of the in-vehicle device control apparatus and in-vehicle device control program according to Embodiment 4 are similar to those of the in-vehicle device control apparatus and in-vehicle device control program according to Embodiment 1, similar elements are identified by the same reference characters, and detailed description thereof will be omitted.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-16. (canceled)

17. A device control apparatus for controlling an operation of a device, comprising:
a first processing section for exchanging information with the device; and
a second processing section for exchanging information with the first processing section, and
wherein the second processing section includes:
an abstraction part for generating abstracted information on the basis of a single piece or a plurality of pieces of information received from the first processing section, the abstracted information being generated by abstracting the received information; and
a control information processing section for performing information processing concerning control of the device by using the generated abstracted information.

18. The device control apparatus according to claim 17,
wherein the second processing section further includes a conversion section for converting abstracted information, generated by the information processing performed by the control information processing section, into an information format suitable for the first processing section, and
wherein the information, converted by the conversion section, is supplied to the first processing section.

19. The device control apparatus according to claim 17, further comprising
a shared processing section for storing information received from one or a plurality of the first processing sections and used by a plurality of the second processing sections, and for performing information processing on the information.

20. The device control apparatus according to claim 17,
wherein the second processing section further includes:
a basic processing part for performing information processing concerning information of a function common to different devices; and
a unique processing part for performing information processing concerning information of a function unique to the associated device.

21. The device control apparatus according to claim 17,
wherein information exchangeable between the second processing section and the first processing section is limited.

22. A device control apparatus for controlling an operation of a device, comprising:
an abstraction part for generating abstracted information on the basis of a single piece or a plurality of pieces of information received from an other device that exchanges information with the device, the abstracted information being generated by abstracting the received information; and
a control information processing section for performing information processing concerning control of the device by using the generated abstracted information.

23. The device control apparatus according to claim 22, further comprising
a conversion section for converting abstracted information, generated by the information processing performed by the control information processing section, into an information format suitable for the other device, and
wherein the information, converted by the conversion section, is supplied to the other device.

24. A recording medium in which a device control program for causing a computer to control an operation of a device is recorded, the device control program comprising:
a first program for causing the computer to exchange information with the device; and
a second program for causing the computer to exchange information with the first program, and
wherein the second program includes the steps of:
causing the computer to generate abstracted information on the basis of a single piece or a plurality of pieces of information received from the first program, the abstracted information being generated by abstracting the received information; and
causing the computer to perform information processing concerning control of the device by using the generated abstracted information.

25. The recording medium according to claim 24,
wherein the second program further includes the steps of:
causing the computer to convert abstracted information, generated by the information processing, into an information format suitable for the first program; and
causing the computer to supply the converted information to the first program.

26. The recording medium according to claim 24, the device control program further comprising
a first program group comprising one or a plurality of the first programs; and
a second program group comprising a plurality of the second programs, and
wherein the second program group includes a shared program for storing information received from the first program of the first program group and used by a plurality of the second programs, and for performing information processing on the information.

27. The recording medium according to claim 24,
wherein the second program further includes:
a basic program portion for performing information processing concerning information of a function common to different devices; and
a unique program portion for performing information processing concerning information of a function unique to the associated device.

28. The recording medium according to claim 24,
wherein information exchangeable between the second program and the first program is limited.

29. A recording medium in which a device control program for causing a computer to control an operation of a device is recorded, the device control program comprising the steps of:
causing the computer to generate abstracted information on the basis of a single piece or a plurality of pieces of information received from an other program that exchanges information with the device, the abstracted information being generated by abstracting the received information; and
causing the computer to perform information processing concerning control of the device by using the generated abstracted information.

30. The recording medium according to claim 29, the device control program further comprising the steps of:
causing the computer to convert abstracted information, generated by the information processing, into an information format suitable for the other program; and
causing the computer to supply the converted information to the other program.

31. A recording medium in which a device control program for causing a device control apparatus to control an operation of a device is recorded, the device control apparatus comprising: a communication section for receiving and transmitting information from and to one or a plurality of devices; an information processing section for performing information processing concerning control of the device on the basis of the info illation received by the communication section; and a storage section for storing information concerning the information processing, the device control program comprising:
a first program for causing the device control apparatus to exchange information with the device by the communication section; and
a second program for causing the device control apparatus to exchange information with the first program via the storage section; and
wherein the second program includes the steps of:
causing the device control apparatus to generate abstracted information on the basis of a single piece or a plurality of pieces of information received from the first program via the storage section, the abstracted information being generated by abstracting the received information by the information processing section; and
causing the device control apparatus to perform, using the generated abstracted information, information processing concerning the control of the device by the information processing section.

32. The recording medium according to claim 31,
wherein the second program further includes the steps of:
causing the device control apparatus to convert abstracted information, generated by the information processing, into an information format suitable for the first program by the information processing section; and
causing the device control apparatus to store the converted information in the storage section by the information processing section, thus supplying the information to the first program via the storage section.
